(19) United States
(12) Patent Application Publication
(10) Pub. No.: US 2011/0234165 A1
(43) Pub. Date: Sep. 29, 2011

(54) Modular Charging System for Multi-Cell Series-Connected Battery Packs

(76) Inventor: Dennis Palatov, Portland, OR (US)

(21) Appl. No.: 12/748,933

(22) Filed: Mar. 29, 2010

(51) Int. Cl. H02J 7/00

(52) U.S. Cl. 320/119; 320/116

(57) ABSTRACT

A modular charging system for series-connected battery packs is disclosed. An individual isolated charging module is connected across each cell in the pack. A battery cell and its corresponding charging module form a battery module assembly, a plurality of which are connected in series to form a complete battery pack of desired characteristics. A common input power input bus is shared between all charging modules and is connected in a daisy-chain fashion to a single input power source. A common isolated communications bus, which may be isolated CAN bus, is similarly shared and daisy-chained between all modules, connecting them to a monitoring processor. The monitoring processor is primarily intended to report the condition of each cell to the pack user or operator and need not actively control the charging of any individual cell. Each cell in a pack is optimally charged by the corresponding charging module. The overall system is readily scaled to any desired pack voltage and is well suited to mass production.

The present invention relates to charging systems for battery packs comprising multiple cells connected in a series configuration, and in particular to electric vehicle battery charging systems.

### BACKGROUND OF THE INVENTION

A variety of battery types exist in the art. Some of the more commonly used batteries are of Lithium Ion type and its various derivatives. A cell voltage of approximately 3.5V is characteristic of these batteries. The power requirements of applications such as electric vehicles and other high-power loads demand overall pack voltages of over 300V and increasingly of 700V and more. A battery pack for such applications consists of sometimes a hundred or more individual cells connected in series to produce the required pack voltage.

In such series-connected configurations, problems arise when charging the pack. Since no two cells are alike due to production variations, some will reach full charge before others. If charging is terminated at the point when the smallest-capacity cell reaches full charge, the entire pack will be significantly under-charged. If bulk charging is continued until the highest-capacity cell is fully charged, the lower-capacity cells will be damaged and may cause hazardous conditions such as fire or explosion.

A number of techniques are known in the art to address this issue and are collectively known as balancing techniques. The most common consist of a switchable shunt load connected across each cell. A central processing unit typically monitors each cell's temperature and voltage to determine its state of charge. When an individual cell reaches full charge before others, the shunt is switched in, effectively bypassing the charging current around the cell and into a typically resistive load. In such a system a temperature sensor, a voltage sensor, a shunt, a switch, and a plurality of signal connections to a central processing/control unit are required for each cell. With sometimes hundreds of cells in a high-voltage pack, such systems are cumbersome, expensive to implement and can be unreliable. Additionally, the shunting of charging current into a resistive load wastes energy and considerably extends charge time. The need for shunt heat management is also added to the list of drawbacks.

A further disadvantage of commonly practiced charging solutions is that a high-power, high-voltage bulk charger is required to convert the typical standard 220V or 110V AC input power into closely regulated DC power supply of a voltage sufficient to charge the entire battery pack. Such units tend to be heavy, cumbersome and expensive. They must also be precisely tailored to the pack voltage. As no standard exists at present for high-power vehicle battery packs, each pack configuration usually requires a custom charger design greatly increasing the cost and delaying time to market.

Improved solutions have been suggested, primarily focusing on more efficient balancing techniques that shunt charging current actively instead of passively through a resistive element. This is exemplified by the approach taught by Tikhonov in U.S. Pat. No. 7,489,106. Instead of resistive shunts, Tikhonov teaches an isolated DC/DC converter coupled to each cell in a pack to regulate shunt current without wasting energy in a resistive load. While addressing the efficiency and pack-balancing problems, Tikhonov's approach is otherwise typical of other prior art in that it relies on a high-power bulk charger and a separate central control unit to manage the entire battery pack. As in other solutions known in the art, this configuration calls for a high-power bulk charger configured specifically to the voltage and power requirements of the entire battery pack, with its corresponding high cost and long time to market. The cost and complexity of individual DC/DC converters taught by Tikhonov is additional to those of the bulk charger.

What is needed is a mass-producible, flexible solution that would cost-effectively charge each cell in a series-connected pack to its optimum capacity. Such charging system should be readily adaptable to any pack voltage without custom development, should eliminate the energy waste characteristic of resistive shunt approaches and should reduce signal and power wiring requirements. The modular charging system of the present invention answers this need.

### SUMMARY OF THE INVENTION

A primary objective of the present invention is to provide a charging system for series-connected battery packs that optimizes charging individually for each cell in the pack without wasting energy in resistive shunts, and is readily scalable to any desired pack voltage. A second objective is to provide a charging system that reduces signal interconnect requirements for a pack, is mass-producible, reliable and cost effective.

To meet the primary objective, according to the present invention, an individual isolated charging module is electrically coupled to each battery cell in the pack. The combination of a battery cell and its corresponding charging module forms a battery module assembly. A plurality of battery module assemblies are connected in series to form a battery pack of desired characteristics. A common input power input bus consisting of two or three wires is shared between all charging modules and is connected in a daisy-chain fashion to a single power input source. The input power bus may be AC or DC and of any available voltage. A common isolated communications bus, which may be isolated CAN bus, is similarly shared and daisy-chained between all modules, connecting them to a monitoring processor. The monitoring processor within the scope of the present invention is primarily intended to report the condition of each cell to the pack user or operator but need not actively control the charging of any individual cell. The control of the charging of each individual cell is primarily accomplished within each corresponding charging module.

Each cell together with its corresponding charging module form a complete battery module assembly that can be connected in series with any number of additional assemblies to form a battery pack of desired characteristics. Such battery module assemblies can be readily mass-produced to achieve favorable economies of scale while allowing complete freedom in configuring battery packs of any desired voltage. A failure of any one charging module in a battery pack is readily detectable by a monitoring processor using known methods and need not affect the operation of any other modules. The interconnect requirements are reduced to the common daisy-chained input power bus usually consisting of two or three wires and the common daisy-chained communications bus typically consisting of between two and four wires. Due to the above listed characteristics, the modular charging system of the present invention also meets the second objective.

### BRIEF DESCRIPTION OF THE DRAWINGS

The present invention is described herein with reference to the following drawings:

FIG. 1 is a schematic illustration of a battery pack utilizing the modular charging system of the present invention; and

FIG. 2 is an illustration of a charging module of the present invention and its interface to the corresponding battery cell.

### DEFINITION OF TERMS

A charging module of the present invention is an electronic circuit designed to convert substantially unregulated input power into galvanically isolated DC output with voltage and current characteristics regulated to optimally charge a single battery cell. A charging module typically incorporates sensors for cell voltage, temperature and optionally current. A charging module is preferably mechanically coupled to its corresponding cell to form a battery module assembly. Many examples of electronic charging circuits exist in the art and numerous charging algorithms are known. The innovation of the present invention directly couples a dedicated galvanically isolated charging module to each of a plurality of series-connected battery cells in a battery pack.

A monitoring processor within the scope of the present invention is an electronic information processing unit, distinct and separate from any charging module, whose function it is to monitor and report the state of charge and any fault conditions within each individual battery cell as well as the pack as a whole. A monitoring processor of the present invention may, either by means of an algorithm or user input, issue control information to one or more charging modules. Such control information may include but is not limited to commands to start, stop or change the rate of charging current supplied by a charging module to its corresponding battery cell. Numerous examples of such monitoring processors and associated communications protocols and means exist in the art and therefore need not be described in detail herein.

Within the scope of the present invention, the term on-board processor means a processing unit associated with a particular battery pack and usually its corresponding load. An example of an on-board monitoring processor is a control unit of an electric or hybrid vehicle, however the scope of the present invention is not limited to vehicles. The term off-board processor when used herein refers to a processing unit associated with a stationary power source to which a number of different battery packs may be connected for charging.

A communications bus within the present invention is a set of physical and logical connections and protocols to facilitate the transfer of digitally-encoded information. Many examples are known in the art, both wired and wireless, including CAN, Ethernet, Zigbee, BlueTooth and others. A communications bus may have its own dedicated set of wires, be superimposed over power input bus wires or use a wireless protocol and hardware.

### DETAILED DESCRIPTION OF AN EMBODIMENT OF THE INVENTION

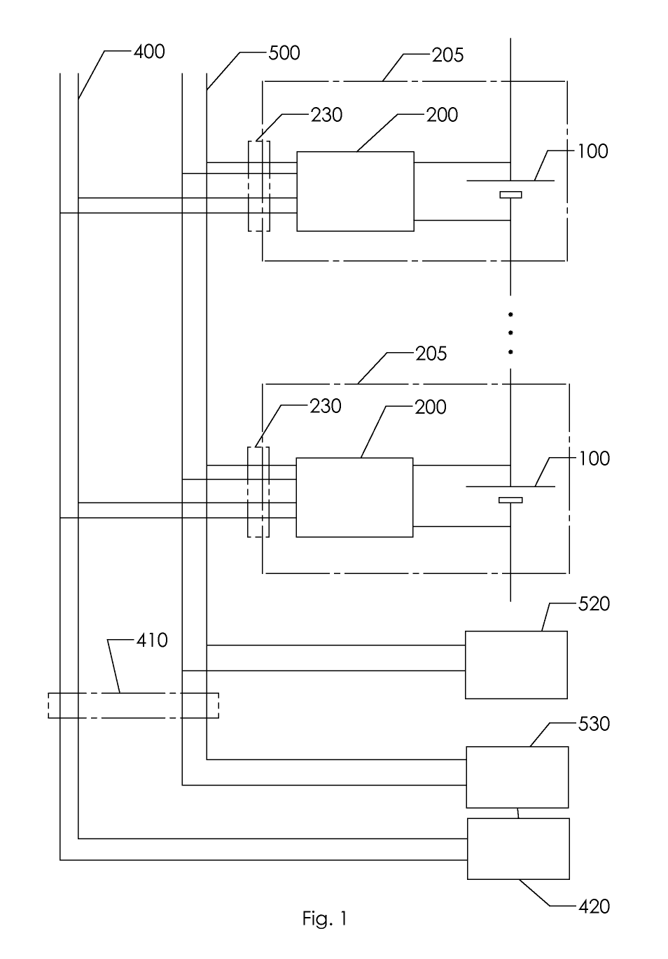

A representative embodiment of the present invention is illustrated schematically in FIG. 1. A plurality of battery cells 100 are connected in series. Each of the cells 100 is electrically coupled to a corresponding charging module 200, together forming battery module assemblies 205. Each battery module assembly 205 is coupled to the input power bus 400 by means of a connector interface 230. Additionally, modules 205 may interface to a communications bus 500. This communications bus interface may be either by means of additional pins in the physical connector 230, as illustrated, or by any other known means including wireless connections such as Zigbee or BlueTooth. FIG. 1 further shows the power source 420 connected to the power input bus 400 by means of connector interface 410. Numerous embodiments of connector interfaces are known in the art and need not be discussed in detail herein. In most embodiments the power source 420 is a utility power grid supplying single-phase or three-phase AC power, however other power sources are possible.

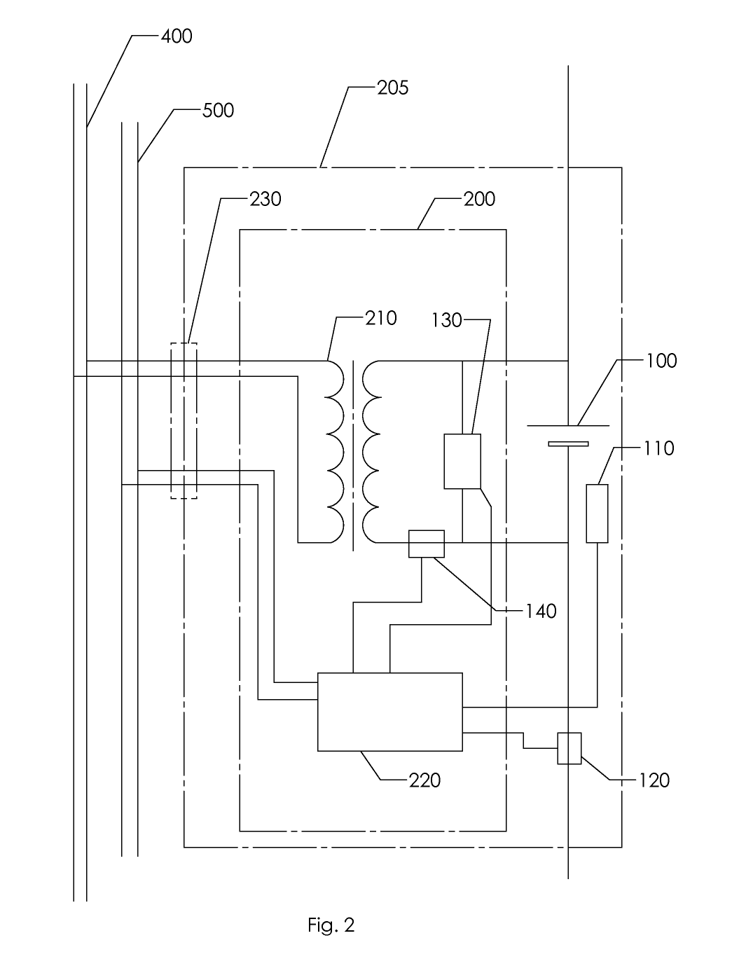

A battery module assembly 205 of the present invention is further illustrated in FIG. 2. Each such assembly comprises at minimum an isolating transformer 210 to convert input power into voltage and current appropriate for charging the attached battery cell 100 while also providing galvanic isolation between input power bus 400 and battery cell 100. The charging module 200 is controlled by microprocessor 220, many examples of which are known in the art. The microprocessor 220 gathers data from one or more of the following: cell voltage sensor 130, cell temperature sensor 110, cell charge current sensor 140 and cell discharge current sensor 120. A charging algorithm is used to control the charging of battery cell 100 based on the gathered data. Charging algorithms are well known in the art and need not be detailed herein. Not all of the above listed sensors need be included in any particular embodiment of the present invention, their inclusion herein is illustrative and not limiting.

In the illustrated embodiment, power is supplied by the power source 420 via power input bus 400 simultaneously to all battery module assemblies 205. Within each battery module assembly 205, a charging module 200 converts the supplied power to a voltage and current appropriate for charging the corresponding battery cell 100 under the control of microprocessor 220. In the embodiments where the power supplied via power input bus 400 is in the form of Alternating Current, Power Factor Correction circuitry of any known type is preferably incorporated into the charging module 200 to make the most efficient use of the power supplied.

The operation of the modular charging system of the present invention typically begins with the application of power to the power input bus 400 from power source 420. Upon the detection of power present on the input power bus, each charging module 200 begins to supply charging current to its corresponding battery cell 100. Optionally, control information may be transmitted from power source 420 or a connected off-board monitoring processor 530 to modules 200, via communications bus 500, to start, stop, delay or configure a specific rate of charge. An example of such control information would be a command to reduce charging current during power utility's peak demand or to delay charging until a specified time when the load on the power source or the cost of power may be lower.

Once charging is started, each module 200 monitors the condition of its corresponding battery cell 100 based on data gathered by the microprocessor 220 and any sensors present. The state of charge information is used to configure the charging current and voltage at any given time. The state-of-charge information is also reported periodically to on-board and off-board monitoring processors 520 and 530, respectively, when present. Such reporting may take place either at predetermined intervals or by request of a monitoring processor. On-board monitoring processor 520 and off-board monitoring processor 530 are illustrated in FIG. 1.

As each cell 100 reaches its full energy storage capacity, as determined by the corresponding charging module 200, the charging current for that cell is reduced to zero and charging of the cell is terminated. The full-charge condition is then optionally reported to one or more monitoring processors, if present.

Each cell 100 in a battery pack of the present invention is therefore optimally charged to its full capacity substantially independent of any other cell in the pack. An optimal charge balance is therefore inherently achieved for the entire pack without the risk of over-charging or damaging any one cell. Since no resistive shunts are used, no energy is wasted to heat dissipation in resistive elements.

The modular charging system of the present invention is inherently scalable and can be used to configure and optimally charge battery packs having any arbitrary number of cells. The combination of battery cells 100 and charging modules 200 into battery module assemblies 205 facilitates mass production of components that can be configured into functional battery packs of a wide variety of voltages and capacities. The modular charging system of the present invention thereby delivers features and benefits not previously available in the solutions known in the art.

The embodiment disclosed herein is illustrative and not limiting; other embodiments shall be readily apparent to those skilled in the art based upon the disclosures made herein, without departing from the scope of the present invention, including embodiments optimized for varied battery cell chemistries, varied input power configurations and varied algorithms for control of individual charging modules and their communications with each other as well as with on-board and off-board processing units.

What is claimed is:

1. A modular battery charging system for a plurality of series-connected battery cells, comprising:
a plurality of substantially identical galvanically isolated charging modules, each said module electrically coupled to a corresponding one of said plurality of series-connected battery cells; and
an input power bus shared between said plurality of charging modules.

2. The modular battery charging system of claim 1 further comprising a communications bus shared between said plurality of charging modules.

3. The modular battery charging system of claim 1 wherein said input power bus is configured to supply 1-phase AC power.

4. The modular battery charging system of claim 1 wherein said input power bus is configured to supply 3-phase AC power.

5. The modular battery charging system of claim 1 wherein each of said galvanically isolated charging modules incorporates Power Factor Correction.

6. The modular battery charging system of claim 2 wherein said communications bus is isolated CAN bus.

7. The modular battery charging system of claim 2 wherein said communications bus is further connected to an on-board monitoring processor.

8. The modular battery charging system of claim 7 wherein said on-board monitoring processor is configured to transmit control information to at least a charging module by means of said communications bus.

9. The modular battery charging system of claim 2 wherein said communications bus is further connected to an off-board monitoring processor.

10. The modular battery charging system of claim 9 wherein said off-board monitoring processor is configured to transmit control information to at least a charging module by means of said communications bus.

11. A method of charging a plurality of series-connected battery cells, each of said cells being electrically coupled to a corresponding one of a plurality of charging modules, said charging modules sharing a common power input bus, said method comprising the steps of:
(a) supplying power to said common power input bus,
(b) individually at each one of said plurality of charging modules initiating the charging process for the corresponding one of said plurality of series-connected battery cells,
(c) individually at each one of said plurality of charging modules controlling the charging current in accordance with the condition of said corresponding one of said plurality of series-connected battery cells, and
(d) individually at each one of said plurality of charging modules terminating the charging process in accordance with the state of charge of said corresponding one of said plurality of series-connected battery cells.

12. The method of claim 11 further comprising the steps of:
(e) individually at one of said plurality of charging modules determining the state of charge of said corresponding one of said plurality of series-connected battery cells,
(f) communicating the state of charge at one of said plurality of series-connected battery cells to a monitoring processor over a communications bus.

13. The method of claim 12 further comprising the step of:
(g) transmitting control information from said monitoring processor to a one of said charging modules over said communications bus.

14. A battery module assembly comprising:
a battery cell; and
a charging module electrically coupled to said battery cell and configured to optimally charge said battery cell.

15. The battery module assembly of claim 14 wherein said charging module is further configured to receive electrical power from an input power bus and is further configured to provide galvanic isolation between said input power bus and said battery cell.

16. The battery module assembly of claim 15 wherein said charging module is further configured to connect to a communications bus.
